(19) United States
(12) Patent Application Publication
(10) Pub. No.: US 2005/0265378 A1
(43) Pub. Date: Dec. 1, 2005

(54) Streaming input-output ports in a digital device

(75) Inventors: Joseph Harry Julicher, Chandler, AZ (US); Cristian P. Masgras, Mesa, AZ (US); Michael Pyska, Phoenix, AZ (US)

Correspondence Address: BAKER BOTTS, LLP, 910 LOUISIANA, HOUSTON, TX, 77002-4995, US

(73) Assignee: Microchip Technology Incorporated

(21) Appl. No.: 11/059,598

(22) Filed: Feb. 16, 2005

Related U.S. Application Data
(60) Provisional application No. 60/574,533, filed on May 26, 2004.

(51) Int. Cl. H04Q 11/00

(52) U.S. Cl. 370/463

(57) ABSTRACT

A digital device comprising a digital processor, a streaming input-output (I/O) port module, and an interface port module having an independent data and control bus may be independently coupled to the streaming I/O port module. The streaming I/O port module may also be coupled to the digital processor, wherein the digital process may control whether the streaming I/O port module is coupled to either the interface port module or the digital processor. The interface port module may also be coupled to the digital processor independently of the streaming I/O port module. The interface port module and the streaming I/O port module may be adapted for parallel and/or serial data transfers. The streaming I/O port may be used to couple an external peripheral device to either the digital processor or to the interface port module.

### RELATED PATENT APPLICATION

This application claims priority to commonly owned U.S. Provisional Patent Application Ser. No. 60/574,533; filed May 26, 2004; entitled “Streaming Parallel Port,” by Joseph Julicher and Cristian P. Masgras; which is hereby incorporated by reference herein for all purposes.

### TECHNICAL FIELD OF THE INVENTION

The present disclosure relates to digital devices and peripherals used in digital systems, more particularly, to streaming input-output ports for the digital devices and/or external peripheral devices.

### BACKGROUND OF THE RELATED TECHNOLOGY

Large transfers of data (high data rate throughput) through a digital device is problematic when other functions of the digital device are desired concurrently therewith. High data rate throughput problems have been addressed in a number of ways, for example: The data is available on a parallel port but it is not driven out the port. The data is buffered in a first-in-first-out (FIFO) memory for external devices to read. A specialized Direct Memory Access (DMA) mode allows data from one device to be moved into a very large memory buffer for subsequent reading or writing by or to the other device. An interface such as a Universal Serial Bus (USB) interface may be designed into an external peripheral device, e.g., application specific integrated circuit (ASIC) with a dedicated digital processor and all required resources therefor. Many current designs use DMA and internal FIFO memory to handle these high data rate throughput problems. Other current designs use internal buffer memory, but do not drive data outside of the digital processor. Instead an outside device must read the desired data out of an internal buffer memory.

Therefore, there is a need for streaming input-output (I/O) ports in a digital device that are independent of other processes occurring in the digital device.

### SUMMARY OF THE INVENTION

The present invention overcomes the above-identified problems as well as other shortcomings and deficiencies of existing technologies by providing an apparatus, system and method for providing streaming input-output (I/O) ports in a digital device that are capable of transferring data independently of other processes occurring in the digital device. The digital device may comprise a digital processor, a streaming I/O port module, and an interface port module having a data and control bus that may be independently coupled to the streaming I/O port module. The streaming I/O port module may also be coupled to the digital processor, wherein the digital process may control coupling of the streaming I/O port module to either the interface port module or the digital processor. The interface port module may also be coupled to the digital processor independently of the streaming I/O port module.

The streaming I/O port may be used to couple an external peripheral device to either the digital processor or to the interface port module, e.g., a USB controller/interface. The digital processor may be a microprocessor, microcontroller, digital signal processor (DSP), application specific integrated circuit (ASIC), programmable logic array (PLA), and the like.

The external peripheral device may be a high data throughput device such as, for example but not limited to, a video camera control ASIC and the like. By providing a high speed path for data from the interface port module (e.g., USB controller/interface) in the digital device, to the external peripheral device (e.g., the video camera control ASIC), via the streaming I/O port module, the digital processor is not required to process this data transfer. Thus, high throughput data transfers occur with substantially no penalty to the digital processor performance because it is performed with hardware between the interface port module and the streaming I/O port module, with substantially no intervention of the digital processor. Furthermore, no buffering of data in memory is required nor desired.

The interface port may be adapted for USB, Firewire, Fibre Channel, and the like. The streaming I/O port may be adapted for a parallel bus, e.g., FIFO memory, random access memory and the like, or a high speed serial and/or parallel bus combination, e.g., RAMBUS and the like. The streaming I/O port may also be configured for proprietary parallel or serial data and control buses of any bus bit width and/or speed that may be configured for the external peripheral device, e.g., video camera control ASIC, audio processor, video motion picture processor, date encryption encoders, data decryption decoders, video compression and decompression, and the like.

A technical advantage of the present invention is no internal memory is required for high throughput data transfers between an interface port and a streaming I/O port of a digital device. Another technical advantage is minimum amount of additional logic is required for high throughput data transfers between the interface port and the streaming I/O port. Still another technical advantage is coupling of a digital processor to the interface port and the streaming I/O port. Other technical advantages should be apparent to one of ordinary skill in the art in view of what has been disclosed herein.

### BRIEF DESCRIPTION OF THE DRAWINGS

A more complete understanding of the present disclosure and advantages thereof may be acquired by referring to the following description taken in conjunction with the accompanying drawings wherein:

FIG. 1 is a schematic block diagram of a digital system, according to a specific exemplary embodiment of the invention; and

FIG. 2 is a schematic block diagram of a typical USB transceiver used with the interface module depicted in FIG. 1.

While the present invention is susceptible to various modifications and alternative forms, specific exemplary embodiments thereof have been shown by way of example in the drawing and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Referring now to the drawings, the details of exemplary embodiments of the present invention are schematically illustrated. Like elements in the drawings will be represented by like numbers, and similar elements will be represented by like numbers with a different lower case letter suffix.

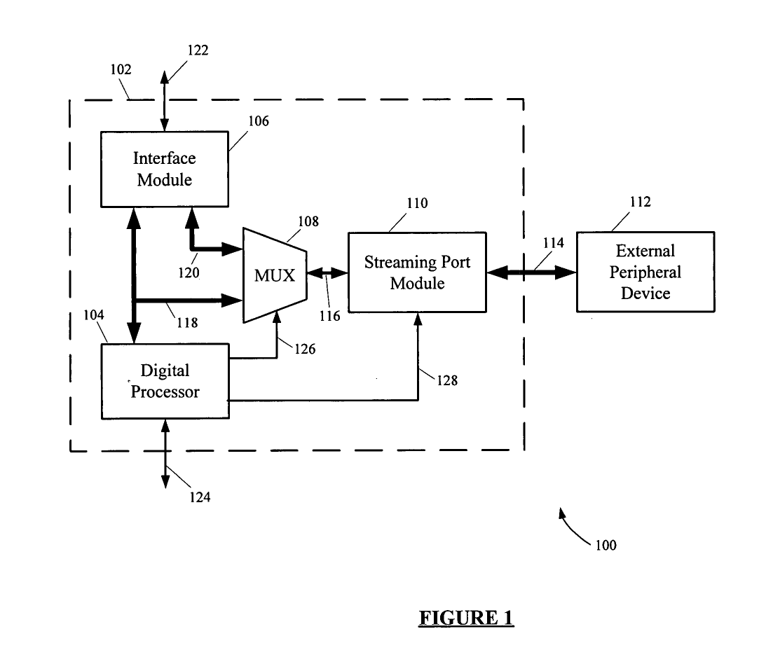

Referring to FIG. 1, depicted is a schematic block diagram of a digital system, according to a specific exemplary embodiment. The digital system, generally represented by the numeral 100, comprises a digital device 102 and an external peripheral device 112. The digital device 102 may comprise a digital processor 104, an interface module 106, a multiplexer 108, and a streaming port module 110. The digital device 102 may be fabricated in a semiconductor integrated circuit (IC), and the IC may be packaged in an integrated circuit package (not shown).

The digital processor 104 may be a microprocessor, microcontroller, digital signal processor (DSP), application specific integrated circuit (ASIC), programmable logic array (PLA), and the like, input-output signal lines thereof are generally represented by the numeral 124. The interface module 106 may be adapted for high speed serial or parallel data transfers on bus 122, e.g., USB, Firewire, Fibre Channel, etc. The streaming port module 110 may be adapted for any high speed parallel or serial bus 114, either for an industry standard bus or a proprietary bus, suitable for coupling to the external peripheral device 112. The streaming port module 110 may be configured by the digital processor 104 over a configuration bus 128. The external peripheral device 112 may be any device that requires high data throughput for its operation.

The multiplexer 108 has a first bi-directional input-output port coupled to the interface module 106 over a first data and control bus 120. The multiplexer 108 also has a second bi-directional input-output port coupled to the digital processor 104 over a second data and control bus 118. The second data and control bus 118 may also couple together the digital processor 104 and the interface module 106. A third bi-directional input-output port couples the multiplexer 108 to the streaming port module 110 over a third data and control bus 116. The multiplexer 108 may be controlled by the digital processor 104 over a control signal line 126, wherein the third data and control bus 116 is selectably coupled to either the first data and control bus 120 or the second data and control bus 118.

When the control signal line 126 is at a first logic level the multiplexer 108 couples the interface module 106 through the first data and control bus 120, the multiplexer third data and control bus 116 to the streaming port module 110 and finally to the external peripheral device 112 through the bus 114. In this data path configuration the external peripheral device 112 directly transfers data to and from the interface module 106 without using the digital processor 104 resources and without requiring any intermediate memory storage of the data therebetween.

When the control signal line 126 is at a second logic level the multiplexer 108 couples the digital processor 104 through the second data and control bus 118, the bus 116 to the streaming port module 110 and finally to the external peripheral device 112 through the bus 114. In this data path configuration the external peripheral device 112 directly transfers data to and from the digital processor 104 without using the interface module 106 resources and without requiring any intermediate memory storage of the data therebetween.

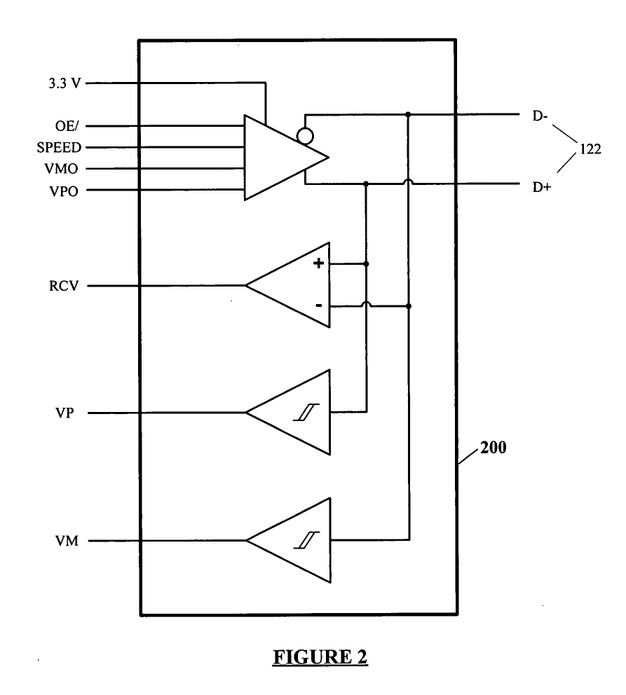

Referring to FIG. 2, depicted is a schematic block diagram of a typical USB transceiver. The typical USB transceiver, generally represented by the numeral 200, may be part of the interface module 106. The USB transceiver 200 comprises an output enable (/OE), slew rate control setting (SPEED), outputs to differential line driver (VMO and VPO), input from differential receiver (RCV), single ended state input of the D+ line (VP), and single ended state input of the D− line (VM).

The invention, therefore, is well adapted to carry out the objects and to attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alteration, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

1. A digital device having streaming input-output (1/O) ports, comprising:
a digital processor;
an interface module coupled to the digital processor;
a streaming port module; and
a multiplexer having a first input-output port coupled to the interface module, a second input-output port coupled to the digital processor and a third input-output port coupled to the streaming port module, wherein the multiplexer couples the streaming port module to either the interface module or the digital processor.

2. The digital device according to claim 1, wherein the digital processor controls the multiplexer for selecting whether the streaming port module is coupled to the interface module or to the digital processor.

3. The digital device according to claim 1, wherein the streaming port module is configured by the digital processor.

4. The digital device according to claim 1, wherein the digital processor is selected from the group consisting of a microprocessor, microcontroller, digital signal processor (DSP), application specific integrated circuit (ASIC) and programmable logic array (PLA).

5. The digital device according to claim 1, wherein the interface module is coupled to a serial bus.

6. The digital device according to claim 5, wherein the serial bus is a Universal Serial Bus (USB).

7. The digital device according to claim 1, wherein the streaming port module is coupled to a parallel bus.

8. The digital device according to claim 1, wherein the streaming port module is coupled to a serial bus.

9. The digital device according to claim 1, wherein the streaming port module is adapted for interfacing with an external peripheral device.

10. The digital device according to claim 9, wherein the external peripheral device has high data throughput.

11. The digital device according to claim 1, wherein the digital processor, the interface module, the streaming port module and the multiplexer are fabricated on an semiconductor integrated circuit.

12. The digital device according to claim 11, wherein the semiconductor integrated circuit is enclosed in an integrated circuit package.

13. A system having an external peripheral device coupled to a digital device, said system comprising:
an external peripheral device; and
a digital device, said digital device comprising,
a streaming port module coupled to the external peripheral device;
a digital processor;
an interface module coupled to the digital processor;
a multiplexer having a first input-output port coupled to the interface module, a second input-output port coupled to the digital processor and a third input-output port coupled to the streaming port module, wherein the multiplexer couples the streaming port module to either the interface module or the digital processor.

14. The system according to claim 13, wherein the external peripheral device transfers data to and from the interface module when the multiplexer couples the first input-output port to the third input-output port.

15. The system according to claim 13, wherein the external peripheral device transfers data to and from the digital processor when the multiplexer couples the second input-output port to the third input-output port.

16. The system according to claim 13, wherein the external peripheral device has high data throughput.

17. The system according to claim 13, wherein the digital processor is selected from the group consisting of a microprocessor, microcontroller, digital signal processor (DSP), application specific integrated circuit (ASIC) and programmable logic array (PLA).

18. The system according to claim 13, wherein the interface module is coupled to a serial bus.

19. The system according to claim 18, wherein the serial bus is a Universal Serial Bus (USB).

20. The system according to claim 13, wherein the streaming port module is coupled to a parallel bus.

21. The system according to claim 13, wherein the streaming port module is coupled to a serial bus.

22. A method for streaming input-output ports in a digital device, said method comprising the steps of:
providing a digital processor;
providing an interface module coupled to an interface bus;
providing a streaming port module coupled to an external peripheral bus;
coupling the interface module to the streaming port module when data is to be transferred directly between the external peripheral bus and the interface bus; and
coupling the digital processor to the streaming port module when data is to be transferred directly between the external peripheral bus and the digital processor.

23. The method according to claim 22, wherein each step of coupling is done with a signal multiplexer.

24. The method according to claim 23, wherein the digital processor controls the signal multiplexer.

25. The method according to claim 22, wherein the interface bus is a serial bus.

26. The method according to claim 22, wherein the interface bus is a Universal Serial Bus (USB).

27. The method according to claim 22, wherein the external peripheral bus is a parallel bus.

28. The method according to claim 22, wherein the external peripheral bus is a serial bus.

29. The method according to claim 22, wherein the digital processor is selected from the group consisting of a microprocessor, microcontroller, digital signal processor (DSP), application specific integrated circuit (ASIC) and programmable logic array (PLA).

30. The method according to claim 22, wherein the external peripheral bus is an industry standard parallel bus.

31. The method according to claim 22, wherein the external peripheral bus is a proprietary parallel bus.

32. The method according to claim 22, wherein the external peripheral bus is an industry standard serial bus.

33. The method according to claim 22, wherein the external peripheral bus is a proprietary serial bus.
